(19) United States
(12) Patent Application Publication
(10) Pub. No.: US 2026/0186395 A1
(43) Pub. Date: Jul. 2, 2026

(54) SOLID STATE LIGHT SOURCE DEVICE, PROJECTION APPARATUS AND ASSEMBLING METHOD FOR SOLID-STATE LIGHT SOURCE DEVICE

(71) Applicant: Coretronic Corporation, Hsin-Chu (TW)

(72) Inventors: Ken-Teng PENG, Hsin-Chu (TW); Wei-Hao CHEN, Hsin-Chu (TW)

(21) Appl. No.: 19/420,858

(22) Filed: Dec. 16, 2025

(30) Foreign Application Priority Data
Dec. 27, 2024 (CN) 2024119474022

(51) Int. Cl. G03B 21/16; G03B 21/20

(52) U.S. Cl. CPC G03B 21/16; G03B 21/2006

(57) ABSTRACT

The disclosure provides a solid-state light source device, a projection apparatus and an assembling method for solid-state light source device. The solid state light source device includes a cooler and a light source module. The cooler includes a chamber, a liquid inlet and a liquid outlet. An opening is formed on a top surface of the chamber. The liquid inlet is located on one sidewall of the chamber. The liquid outlet is located on another sidewall of the chamber. The light source module is disposed on a top surface of the cooler. The light source module covers the opening. Therefore, through the opening, the light source module contacts a liquid of the chamber such that heat generated by the light source module is taken away by the liquid. The efficiency of heat dissipation of the light source module may be improved.

### CROSS-REFERENCE TO RELATED APPLICATIONS

This application claims the benefit of and priority to Chinese Patent Application No. 2024119474022, filed on Dec. 27, 2024, the disclosure of which is incorporated herein by reference in its entirety.

### BACKGROUND

### Technical Field

The present disclosure relates to the technical field of light source devices, and more particularly to a solid-state light source device, a projection apparatus having the solid-state light source device, and a method for assembling the solid-state light source device.

### Description of the Related Art

A conventional light source device includes a light source module (e.g., a laser diode), a metal plate, and a heat sink. First, the light source module is disposed on a top surface of the metal plate. Then, the metal plate with the light source module mounted thereon is entirely attached to a top surface of the heat sink. When the light source module emits light and generates a large amount of heat, the heat is transferred through lateral heat spreading by the metal plate, so that the heat of the light source module can be conducted to the top surface of the heat sink, thereby allowing the heat to be effectively dissipated via the heat sink.

However, in the conventional light source device, due to limitations on the structural strength, the metal plate is required to have a relatively large thickness. As a result, the increased thickness of the metal plate directly leads to an increase in thermal resistance, thereby significantly reducing heat dissipation efficiency. In addition, to achieve effective heat dissipation, the flatness of the contact surface between the metal plate and the heat sink must be strictly controlled, which in turn greatly increases the manufacturing cost of the metal plate.

Therefore, there remains a need in the prior art to provide an improved solution.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

In view of the shortcomings of the prior art described above, a primary objective of the present disclosure is to provide a solid-state light source device with a liquid cooler, so as to reduce the influence of the metal plate on heat dissipation, thereby improving heat dissipation efficiency and lowering manufacturing costs.

Other objectives and advantages of the present disclosure can be further understood from the technical features disclosed herein.

To achieve one or part or all of the above-mentioned objectives, or other objectives, an embodiment of the present disclosure provides a solid-state light source device, which includes:
a liquid cooler and a light source module. The liquid cooler includes: a chamber, a liquid inlet, and a liquid outlet. An opening is formed on a top surface of the chamber. The liquid inlet is formed on a sidewall of the chamber, and the liquid outlet is formed on another sidewall of the chamber. The light source module is disposed on the top surface of the liquid cooler and covers the opening.

In an embodiment of the present disclosure, the liquid cooler further includes a first recess, which is provided adjacent to the opening and recessed downward along an outer periphery of the opening.

In an embodiment of the present disclosure, a portion of a bottom surface of the light source module is located above the first recess.

In an embodiment of the present disclosure, the light source module includes: a light-emitting component, an elastic member, a plate member, and a circuit board. The elastic member is disposed at the bottom of the light-emitting component, and a portion of the elastic member is in contact with a portion of the bottom surface of the light-emitting component. The plate member is located on the top surface of the liquid cooler and on the elastic member, and is configured to expose a portion of the light-emitting component. The circuit board is located on the top surface of the liquid cooler and on the plate member, and is configured to expose a portion of the plate member and a portion of the light-emitting component.

In an embodiment of the present disclosure, the light-emitting component includes: a plurality of light-emitting elements, a thermally conductive plate, and a plurality of electrical connection wires. The plurality of light-emitting elements is disposed within the thermally conductive plate. The thermally conductive plate includes a first coupling member and a second coupling member. The first coupling member extends outward from a front sidewall of the thermally conductive plate near a bottom portion thereof. The second coupling member extends outward from a rear sidewall of the thermally conductive plate near a bottom portion thereof. The plurality of electrical connection wires is respectively connected to the plurality of light-emitting elements and pass through the thermally conductive plate.

In an embodiment of the present disclosure, the elastic member includes: a first top surface, a side surface, a first bottom surface, and an extension surface. The first top surface faces and contacts the first coupling member and the second coupling member, respectively. The side surface surrounds the light-emitting component. The first bottom surface is connected to the side surface. The extension surface extends outward from an outer side of the side surface, and the extension surface and the first bottom surface form a stepped structure.

In an embodiment of the present disclosure, the first top surface is disposed above the first coupling member and the second coupling member.

In an embodiment of the present disclosure, the first bottom surface is located above the first recess, and a bottom surface of the extension surface is located on a portion of the top surface of the liquid cooler.

In an embodiment of the present disclosure, the elastic member further includes a first rib and a second rib. The first rib protrudes downward from a bottom surface of the first bottom surface and is annular in shape. The second rib protrudes downward from a bottom surface of the extension surface and is also annular in shape.

In an embodiment of the present disclosure, the plate member surrounds the light-emitting component and includes a first through hole. The plate member further includes a second recess formed by flaring outward from the first through hole.

In an embodiment of the present disclosure, the circuit board surrounds the light-emitting component and includes two protrusions. The two protrusions have a plurality of side grooves arranged at intervals from one another.

To achieve one or part or all of the above-mentioned objectives, or other objectives, an embodiment of the present disclosure provides a projection apparatus, which includes: the above-mentioned solid-state light source device, an optical engine module, and a projection lens. The optical engine module is configured to receive a light beam emitted from the light source module and convert the light beam into an image beam. The projection lens is disposed on a transmission path of the image beam to project the image beam.

To achieve one or part or all of the above-mentioned objectives, or other objectives, an embodiment of the present disclosure provides a method for assembling a solid-state light source device, comprising the following steps: providing a light-emitting component and an elastic member; fitting the elastic member onto a bottom portion of the light-emitting component; providing a liquid cooler, wherein the liquid cooler includes a chamber, a liquid inlet, and a liquid outlet; the top surface of the chamber having an opening, and the liquid inlet and the liquid outlet are located on two sidewalls of the chamber; covering the opening with a bottom surface of the light-emitting component that has the elastic member fitted thereon; providing a plate member; placing the plate member on the light-emitting component with the elastic member and the liquid cooler, with a portion of the light-emitting component exposed from the plate member; providing a circuit board; placing the circuit board on the plate member and the liquid cooler, with a portion of the light-emitting component with the elastic member and a portion of the plate member exposed from the circuit board; and moving the circuit board to a soldering position.

In an embodiment of the present disclosure, the method further includes: fastening the plate member to the liquid cooler with a plurality of screws, and fastening the plate member and the light-emitting component fitted with the elastic member to the liquid cooler with a plurality of screws.

In an embodiment of the present disclosure, the method further includes: fastening the circuit board to the liquid cooler with a plurality of screws.

Through the above-mentioned solid-state light source device, projection apparatus, and assembly method, the light source module can directly contact the liquid inside the chamber via the opening, allowing heat dissipation without relying on indirect transfer through the top surface of the liquid cooler, thereby enhancing heat dissipation efficiency. Furthermore, the bottom surface of the light source module is not constrained by the flatness of the contact surface, yet effective heat dissipation can still be achieved, thereby reducing manufacturing costs.

Other objectives, features and advantages of the present application will be further understood from the further technological features disclosed by the embodiments of the present application wherein there are shown and described preferred embodiments of this invention, simply by way of illustration of modes best suited to carry out the invention.

### BRIEF DESCRIPTION OF DRAWINGS

The accompanying drawings presented herein serve to deepen the understanding of the present application and are an integral part thereof. The illustrative embodiments and their explanations are provided to elucidate the present application and do not impose any undue limitations on it. In the drawings:

FIG. 1 is a perspective view of a solid-state light source device according to the present disclosure;

FIG. 2 is a top view of the solid-state light source device according to the present disclosure;

FIG. 3 is an exploded view of the solid-state light source device according to the present disclosure;

FIG. 4 is a cross-sectional view taken along line A-A′ of FIG. 2;

FIG. 5 is a cross-sectional view taken along line B-B′ of FIG. 2;

FIG. 6 is a block diagram of a projection apparatus according to the present disclosure;

FIG. 7 is a flowchart of a method for assembling the solid-state light source device according to the present disclosure;

FIG. 8 is another flowchart of the method for assembling the solid-state light source device according to the present disclosure;

FIG. 9 is still another flowchart of the method for assembling the solid-state light source device according to the present disclosure;

FIG. 10 is a schematic diagram showing the assembly of the light-emitting component and the elastic member according to the present disclosure;

FIG. 11 is a schematic diagram showing the assembly of various components according to the present disclosure;

FIG. 12 is another schematic diagram showing the assembly of various components according to the present disclosure;

FIG. 13 is a top view of the solid-state light source device after the circuit board is assembled, according to the present disclosure; and

FIG. 14 is a schematic diagram showing the translational movement of the circuit board according to the present disclosure.

### DETAILED DESCRIPTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

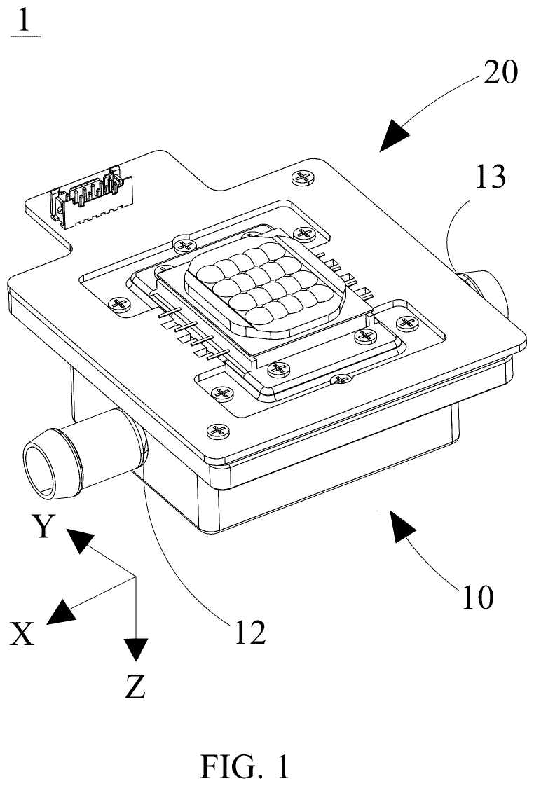

FIG. 1 is a perspective view of the solid-state light source device according to the present disclosure. As shown in FIG. 1, the solid-state light source device 1 includes a liquid cooler 10 and a light source module 20. The light source module 20 is fixed to the liquid cooler 10 and is located on a top surface of the liquid cooler 10, such that a bottom surface of the light source module 20 can be in contact with liquid inside the liquid cooler 10 for dissipating heat from the light source module 20 through the flowing liquid. In this embodiment, the liquid inside the liquid cooler 10 may be water or other cooling liquid. A first direction X, a second direction Y, and a third direction Z are defined, wherein the first direction X, the second direction Y, and the third direction Z are mutually perpendicular.

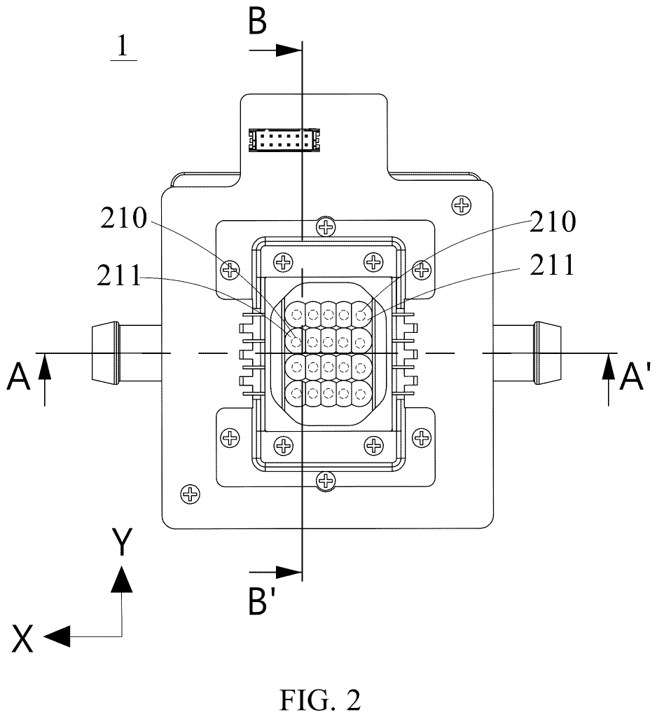

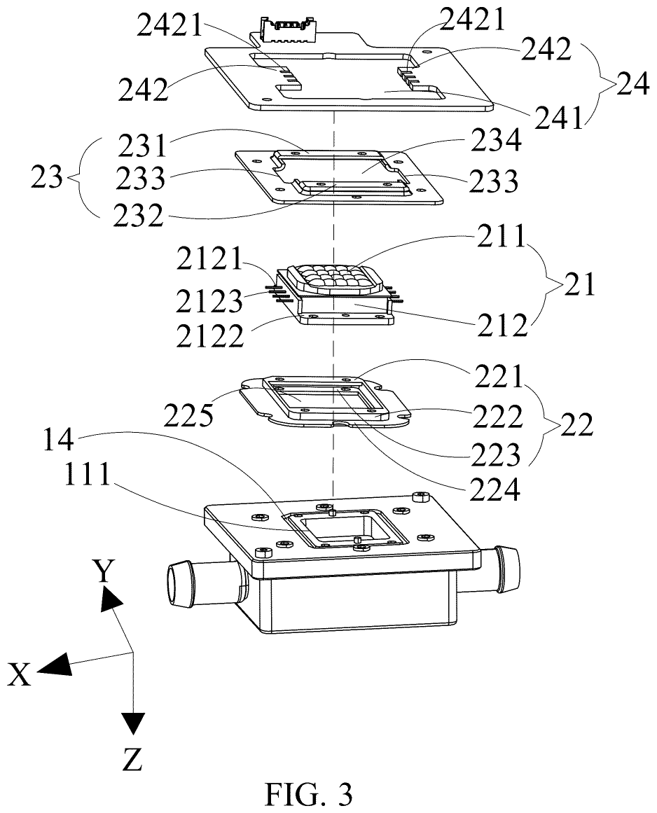

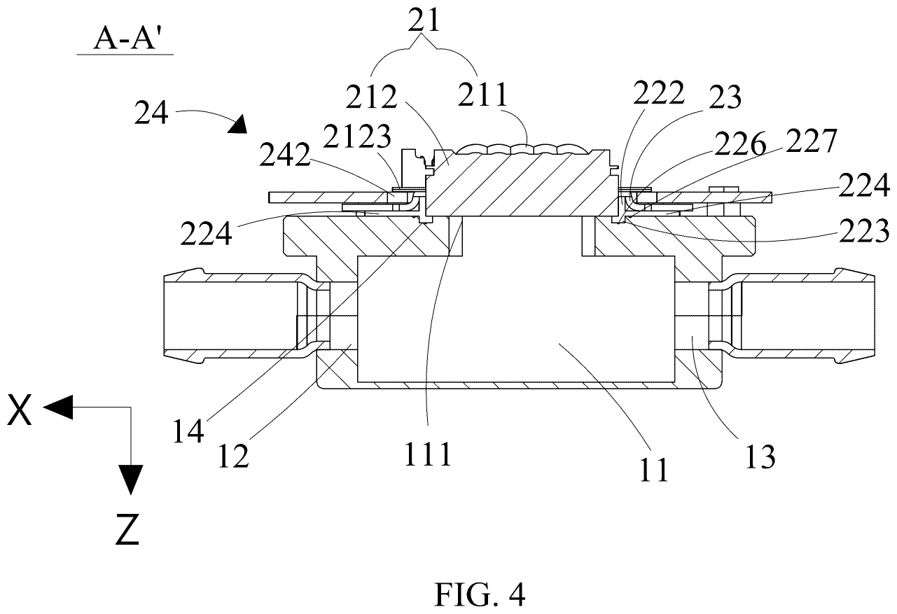

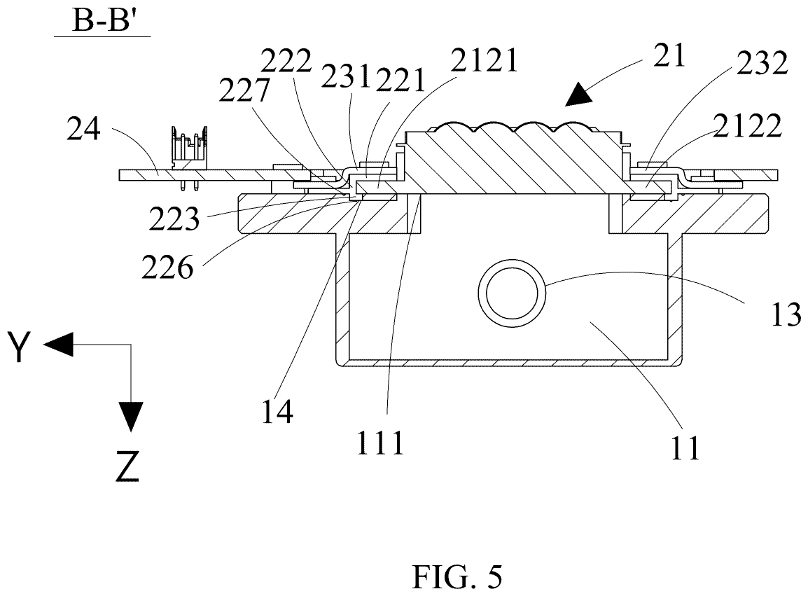

Specifically, FIG. 2 is a top view of the solid-state light source device according to the present disclosure. FIG. 3 is an exploded view of the solid-state light source device. FIG. 4 is a cross-sectional view taken along line A-A′ of FIG. 2. FIG. 5 is a cross-sectional view taken along line B-B′ of FIG. 2. The cross-sectional view A-A′ is taken along the direction of the liquid inlet and the liquid outlet of the solid-state light source device 1, while the cross-sectional view B-B′ is taken from the side of the liquid cooler 10 where neither the liquid inlet nor the liquid outlet is provided. As shown in FIGS. 2 to 5, the liquid cooler 10 includes a chamber 11, a liquid inlet 12, and a liquid outlet 13. The chamber 11 is located inside the liquid cooler 10, and the liquid cooler 10 has an opening 111 formed on a top surface of the chamber 11. The liquid inlet 12 is located on a sidewall of the chamber 11, and the liquid outlet 13 is located on another sidewall of the chamber 11. Specifically, the liquid inlet 12 and the liquid outlet 13 are disposed on opposite sidewalls such that liquid can flow into the chamber 11 through the liquid inlet 12 and exit through the liquid outlet 13. The light source module 20 is disposed on the top surface of the liquid cooler 10, with a bottom surface of the light source module 20 covering the opening 111 of the liquid cooler 10. The bottom surface of the light source module 20 is larger than the opening 111. As the liquid flows into the chamber 11 via the liquid inlet 12, it contacts the bottom surface of the light source module 20 through the opening 111. The liquid carries away heat generated by the light source module 20 and, once heated, exits the chamber 11 through the liquid outlet 13 to the exterior of the liquid cooler 10. In this manner, the light source module 20 achieves heat dissipation.

In one embodiment, as shown in FIGS. 3, 4, and 5, the liquid cooler 10 further includes a first recess 14. The first recess 14 is disposed adjacent to the opening 111 and is recessed downward from the top surface of the liquid cooler 10 along an outer periphery of the opening 111. In other words, the first recess 14 surrounds the outer periphery of the opening 111.

In an embodiment, a portion of the bottom surface of the light source module 20 is located above the first recess 14.

In an embodiment, as shown in FIGS. 2, 3, 4, and 5, the light source module 20 includes a light-emitting component 21, an elastic member 22, a plate member 23, and a circuit board 24. The elastic member 22 is disposed at the bottom of the light-emitting component 21, and a portion of the elastic member 22 is in contact with a portion of the bottom surface of the light-emitting component 21. The plate member 23 is located on the top surface of the liquid cooler 10 and on the elastic member 22, and is configured to expose a portion of the light-emitting component 21. The circuit board 24 is located on the top surface of the liquid cooler 10 and on the plate member 23, and is configured to expose a portion of the light-emitting component 21 and a portion of the plate member 23.

In detail, referring to FIG. 2, the light-emitting component 21 includes a plurality of light-emitting elements 210, a lens array 211, and a thermally conductive plate 212. The light-emitting elements 210 are covered by the lens array 211 and are disposed within the thermally conductive plate 212. The light-emitting elements 210 are in contact with the thermally conductive plate 212, which dissipates heat generated by the light-emitting elements 210. The light-emitting component 21 further includes a plurality of electrical connection wires 2123. The plurality of light-emitting elements 210 are respectively connected to the plurality of electrical connection wires 2123, and the electrical connection wires 2123 pass through the thermally conductive plate 212. Specifically, the thermally conductive plate 212 includes a first coupling member 2121 and a second coupling member 2122. Referring to FIG. 5, the first coupling member 2121 extends outward from a front sidewall of the thermally conductive plate 212 near its bottom and is perpendicularly adjacent to the front sidewall. The second coupling member 2122 extends outward from a rear sidewall of the thermally conductive plate 212 near its bottom and is perpendicularly adjacent to the rear sidewall. More specifically, along the second direction Y, the first coupling member 2121 and the second coupling member 2122 extend respectively from the front and rear sidewalls of the thermally conductive plate 212. Along the first direction X, the electrical connection wires 2123 extend outward from a sidewall of the thermally conductive plate 212. In this embodiment, the light-emitting elements 210 are solid-state light sources, such as laser diodes or light-emitting diodes (LEDs), which emit light beams. The thermally conductive plate 212 may be made of a metal material, such as copper.

In one embodiment, the elastic member 22 includes a first top surface 221, a side surface 222, a first bottom surface 223, and an extension surface 224. The first top surface 221 faces and contacts the first coupling member 2121 and the second coupling member 2122. The side surface 222 surrounds the light-emitting component 21. The first bottom surface 223 is connected to the side surface 222. The extension surface 224 extends outward from the outer side of the side surface 222. The extension surface 224 forms a stepped structure with the first bottom surface 223. Specifically, the elastic member 22 further includes an opening 225 configured to receive the light-emitting component 21. The first top surface 221 is disposed above the first coupling member 2121 and the second coupling member 2122. A stepped structure is formed between the extension surface 224 and the first bottom surface 223. In this embodiment, portions of the first coupling member 2121 and the second coupling member 2122 are accommodated within the first top surface 221, the side surface 222, and the first bottom surface 223. The first bottom surface 223 is located above the first recess 14, and a bottom surface of the extension surface 224 is located on a portion of the top surface of the liquid cooler 10. In this way, the stepped structure formed by the first bottom surface 223 and the extension surface 224 tightly corresponds to and mates with the first recess 14 and the top surface of the liquid cooler 10, thereby preventing leakage of liquid from the chamber 11. In this embodiment, the elastic member 22 may be made of rubber.

In one embodiment, the elastic member 22 further includes a first rib 226 and a second rib 227. The first rib 226 is located approximately at the center of the bottom surface of the first bottom surface 223 and protrudes downward from the bottom surface of the first bottom surface 223. The first rib 226 is annular in shape. The second rib 227 is located on the extension surface 224 near the side surface 222 and protrudes downward from the bottom surface of the extension surface 224. The second rib 227 is also annular. By providing the first rib 226 and the second rib 227, two sealing rings are formed between the light source module 20 and the top surface of the liquid cooler 10, thereby preventing liquid from leaking through gaps between the light source module 20 and the top surface of the liquid cooler 10. In this embodiment, the first rib 226 and the second rib 227 are integrally formed with the elastic member 22 and are therefore also made of rubber.

In one embodiment, the plate member 23 surrounds the light-emitting component 21 and includes a first through hole 234, which is configured to receive the light-emitting component 21. A front stepped surface 231 of the plate member 23 corresponds to the first coupling member 2121, and a rear stepped surface 232 corresponds to the second coupling member 2122. The plate member 23 further includes a second recess 233 formed by flaring outward from the first through hole 234. The plate member 23 may be made of a metal material, such as aluminum or stainless steel.

In one embodiment, the circuit board 24 surrounds the light-emitting component 21 and includes a second through hole 241, which is configured to receive the light-emitting component 21. The circuit board 24 has two protrusions 242, which respectively correspond to the second recesses 233 of the plate member 23. Each protrusion 242 includes a plurality of side grooves 2421, which are spaced apart from one another. Specifically, the protrusions 242 extend toward the second through hole 241. The side grooves 2421 are formed as inward recesses on the sides of the protrusions 242 near the second through hole 241. Through the arrangement of the side grooves 2421, when the circuit board 24 is assembled with the light-emitting component 21, each electrical connection wire 2123 is soldered to the protrusions 242 of the circuit board 24, and each electrical connection wire 2123 is located above the protrusions 242.

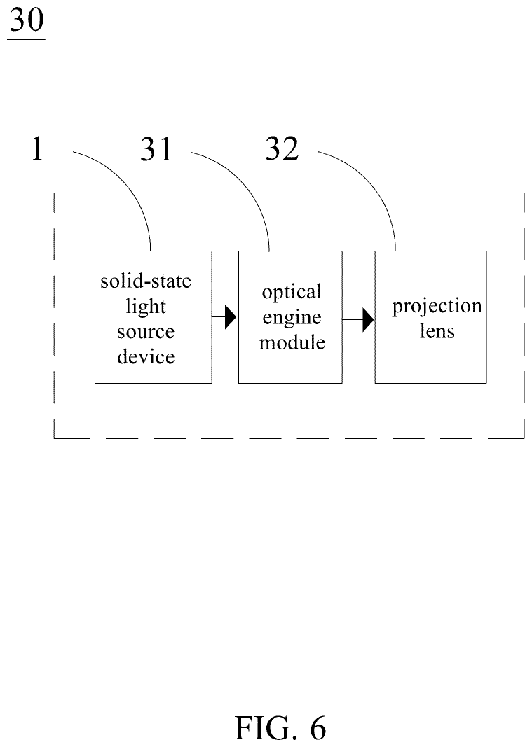

FIG. 6 is a block diagram of a projection apparatus according to the present disclosure. As shown in FIG. 6, the projection apparatus 30 includes the aforementioned solid-state light source device 1, an optical engine module 31, and a projection lens 32. The solid-state light source device 1 is configured to provide a light beam. The optical engine module 31 is used to receive the light beam emitted from the light source module 20 and to convert the light beam into an image beam. The projection lens 32 is arranged along the transmission path of the image beam to project the image. In one embodiment, the optical engine module 31 may include a phosphor wheel, a light-guiding element (e.g., a lens or a mirror), and a light valve, but is not limited thereto. The light valve may be a reflective spatial light modulator such as a Liquid Crystal on Silicon (LCoS) panel or a Digital Micro-Mirror Device (DMD). The projection lens 32 may include a combination of one or more optical lenses with dioptric power, for example, combinations of non-planar lenses such as biconcave lenses, biconvex lenses, concave-convex lenses, convex-concave lenses, plano-convex lenses, and plano-concave lenses.

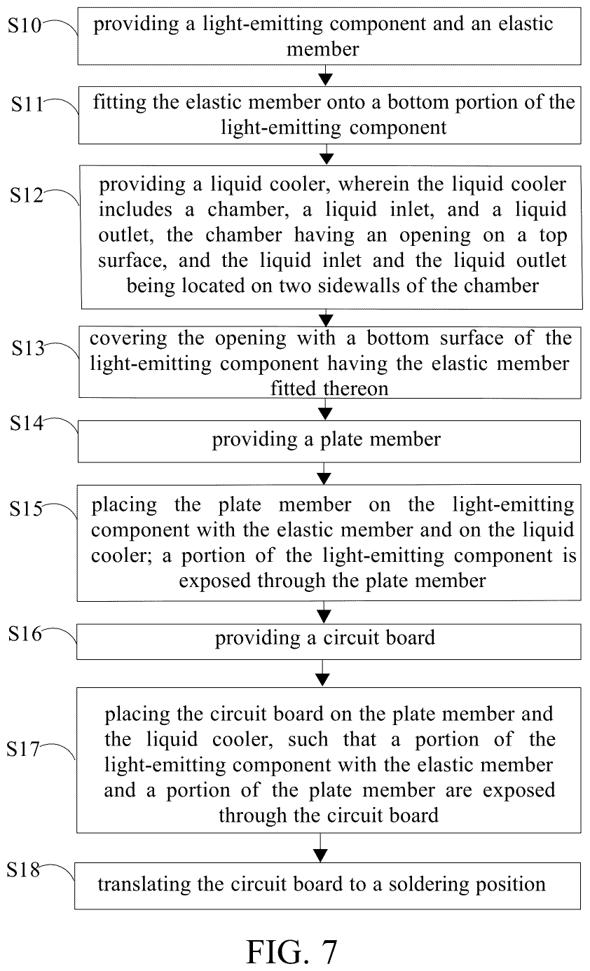

FIG. 7 is a flowchart of a method for assembling the solid-state light source device according to the present disclosure. As shown in FIG. 7, the method for assembling the solid-state light source device 1 includes the following steps, but the assembly sequence is not limited thereto:
providing a light-emitting component and an elastic member (S10);
fitting the elastic member onto a bottom portion of the light-emitting component (S11);
providing a liquid cooler, wherein the liquid cooler includes a chamber, a liquid inlet, and a liquid outlet, the chamber having an opening on a top surface, and the liquid inlet and the liquid outlet being located on two sidewalls of the chamber (S12);
covering the opening with a bottom surface of the light-emitting component having the elastic member fitted thereon (S13);
providing a plate member (S14);
placing the plate member on the light-emitting component with the elastic member and on the liquid cooler; a portion of the light-emitting component is exposed through the plate member (S15);
providing a circuit board (S16);
placing the circuit board on the plate member and the liquid cooler, such that a portion of the light-emitting component with the elastic member and a portion of the plate member are exposed through the circuit board (S17); and
translating the circuit board to a soldering position (S18).

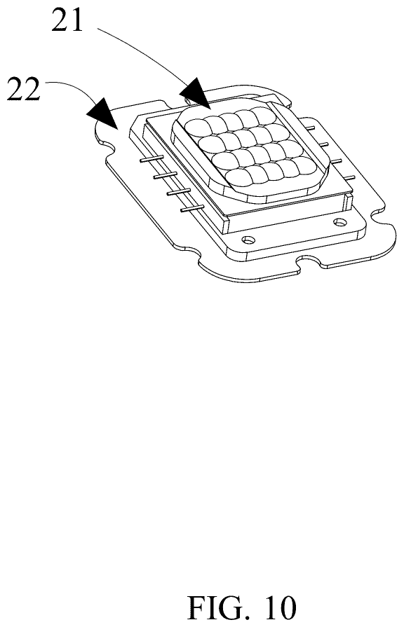

In detail, FIG. 10 is a schematic diagram illustrating the assembly of the light-emitting component 21 and the elastic member 22 according to the present disclosure. As shown in FIGS. 3, 7, and 10, during the execution of steps S10 and S11, the light-emitting component 21 and the elastic member 22 are provided. The operator fits the elastic member 22 onto the bottom portion of the light-emitting component 21 such that the first top surface 221 of the elastic member 22 covers the top surfaces of the first coupling member 2121 and the second coupling member 2122 of the thermally conductive plate 212.

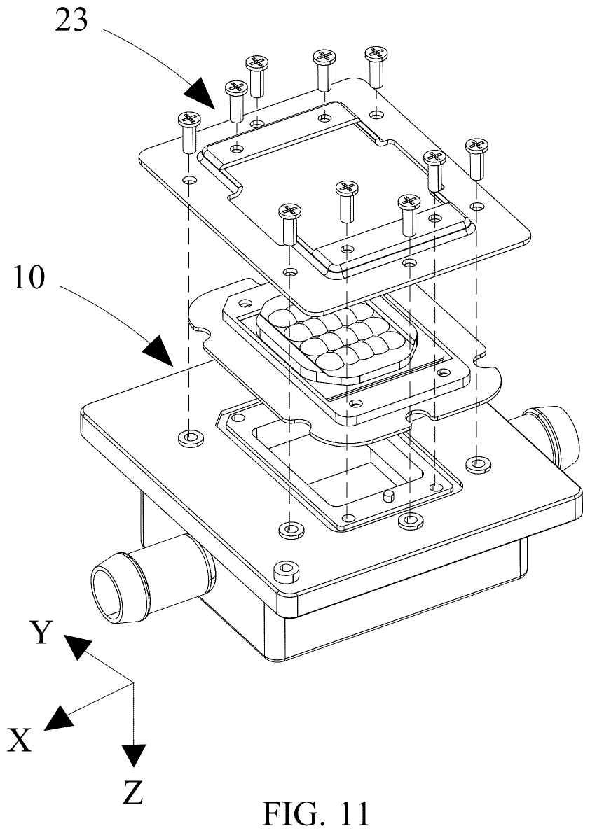

FIG. 11 is a schematic diagram showing the assembly of various components according to the present disclosure. As shown in FIGS. 7 and 11, during the execution of step S12, the liquid cooler 10 is provided. Then, in step S13, the bottom surface of the light-emitting component 21, which has the elastic member 22 fitted thereon, is aligned with the opening 111 of the liquid cooler 10 and is placed to cover the opening 111. This allows the bottom surface of the light-emitting component 21 with the elastic member 22 to come into contact with the liquid inside the chamber 11 of the liquid cooler 10 through the opening 111, thereby achieving a heat dissipation effect. The bottom surface of the light-emitting component 21 with the elastic member 22 is larger than the diameter of the opening 111 and covers the opening 111. In step S14, the plate member 23 is provided. In step S15, the plate member 23 is placed on the light-emitting component 21 with the elastic member 22 and on the liquid cooler 10, with a portion of the light-emitting component 21 exposed through the plate member 23. The plate member 23, the light-emitting component 21 with the elastic member 22, and the liquid cooler 10 are secured together using a plurality of screws.

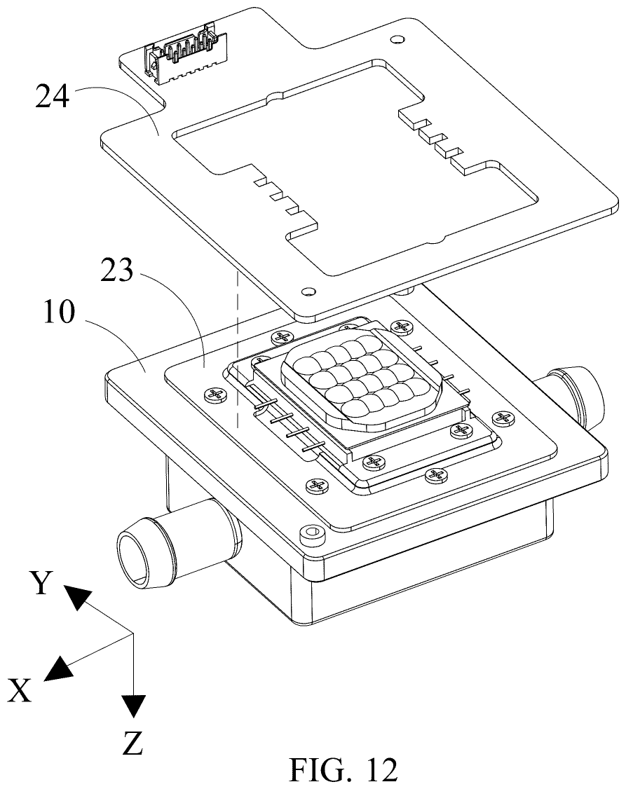

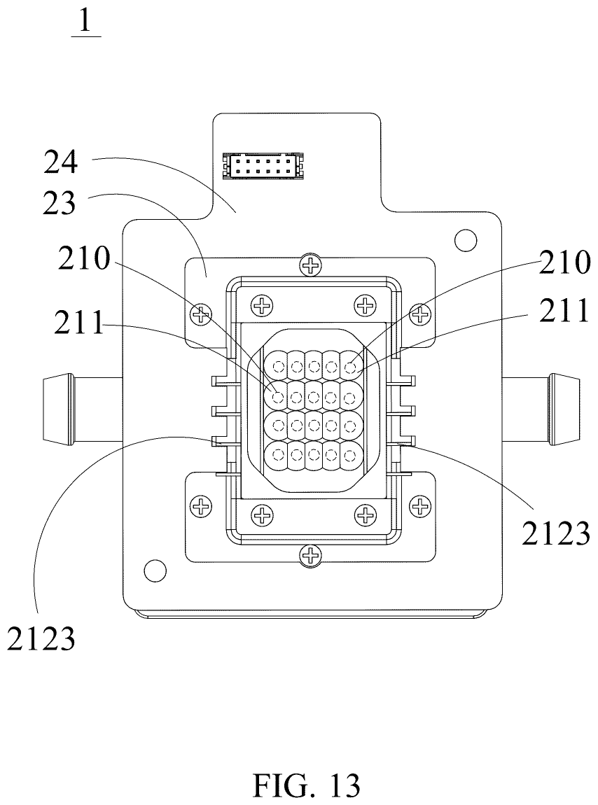

FIG. 12 is another schematic diagram showing the assembly of various components according to the present disclosure. FIG. 13 is a top view of the solid-state light source device after the circuit board is assembled. As shown in FIGS. 7, 12, and 13, in step S16, the circuit board 24 is provided. Subsequently, in step S17, the circuit board 24 is placed on the plate member 23 and the liquid cooler 10. A portion of the light-emitting component 21 with the elastic member 22 and a portion of the plate member 23 are exposed through the circuit board 24. The circuit board 24 and the liquid cooler 10 are secured together with a plurality of screws.

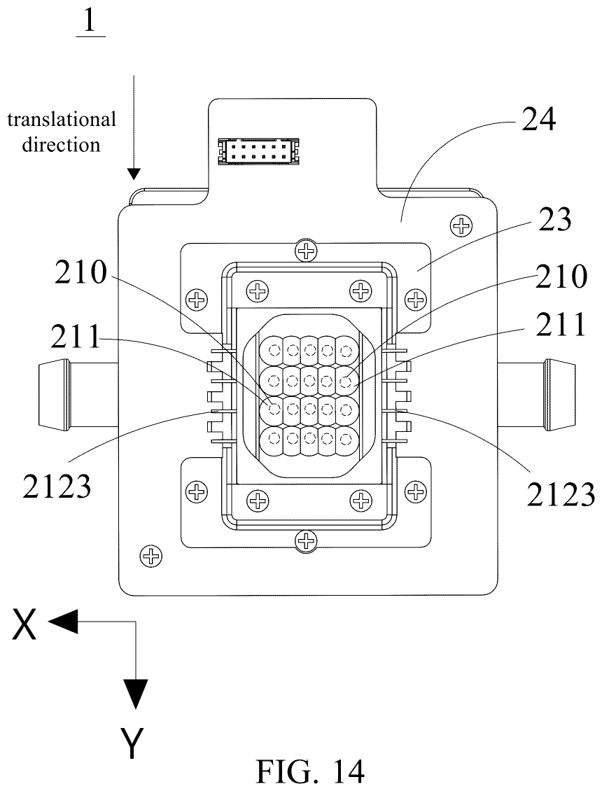

FIG. 14 is a schematic diagram illustrating the translational movement of the circuit board according to the present disclosure. As shown in FIGS. 7, 13, and 14, after each electrical connection wire 2123 passes through the side grooves 2421 of the circuit board 24, step S18 is executed to translate the circuit board 24 along the translation direction (i.e., the second direction Y) to the soldering position of the protrusions 242, thereby establishing electrical connections between the electrical connection wires 2123 and the circuit board 24.

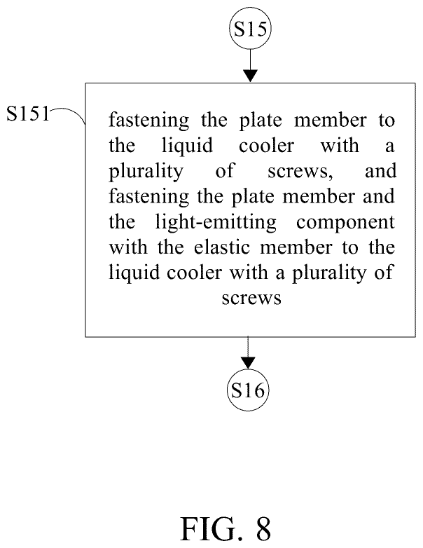

FIG. 8 is another flowchart of the method for assembling the solid-state light source device according to the present disclosure. In this embodiment, steps S11 to S18 are generally the same as those described in the previous embodiment. The difference lies in that, as shown in FIGS. 8 and 11, after the step of “placing the plate member on the light-emitting component with the elastic member and on the liquid cooler, such that a portion of the light-emitting component is exposed through the plate member (S15)” is performed, the assembly method further includes the following step: fastening the plate member to the liquid cooler with a plurality of screws, and fastening the plate member and the light-emitting component with the elastic member to the liquid cooler with a plurality of screws (S151).

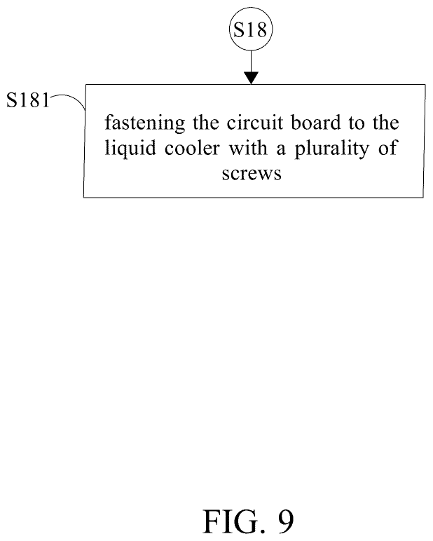

FIG. 9 is still another flowchart of the method for assembling the solid-state light source device according to the present disclosure. In this embodiment, steps S11 to S18 are generally the same as those described in the previous embodiment. The difference lies in that, as shown in FIGS. 9 and 14, after the step of “translating the circuit board to a soldering position (S18)” is performed, the assembly method further includes the following sub-step: fastening the circuit board to the liquid cooler with a plurality of screws (S181).

In summary, the solid-state light source device, the projection apparatus, and the method for assembling the solid-state light source device according to the embodiments of the present disclosure offer at least one of the following advantages. The light source module can directly contact the liquid inside the chamber through the opening, allowing heat to be dissipated without relying on indirect transfer through the top surface of the liquid cooler, thereby enhancing heat dissipation efficiency. Moreover, the bottom surface of the light source module is not constrained by the flatness of the contact surface and can still achieve effective heat dissipation, thereby reducing manufacturing costs.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present application” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present application as defined by the following claims. Moreover, no element and component in the present disclosure is intended to be dedicated to the public regardless of whether the element or component is explicitly recited in the following claims.

1. A solid-state light source device, comprising:
a liquid cooler, comprising:
a chamber, a top surface of the chamber defining an opening;
a liquid inlet, formed on one sidewall of the chamber;
a liquid outlet, formed on another sidewall of the chamber; and
a light source module, disposed on a top surface of the liquid cooler and covering the opening.

2. The solid-state light source device of claim 1, wherein the liquid cooler further comprises a first recess disposed adjacent to the opening and recessed downward along an outer periphery of the opening.

3. The solid-state light source device of claim 2, wherein a portion of a bottom surface of the light source module is located above the first recess.

4. The solid-state light source device of claim 2, wherein the light source module comprises:
a light-emitting component;
an elastic member, disposed at a bottom of the light-emitting component, wherein a portion of the elastic member is in contact with a portion of the bottom surface of the light-emitting component;
a plate member, disposed on the top surface of the liquid cooler and on the elastic member, and configured to expose a portion of the light-emitting component; and
a circuit board, disposed on the top surface of the liquid cooler and on the plate member, and configured to expose a portion of the plate member and a portion of the light-emitting component.

5. The solid-state light source device of claim 4, wherein the light-emitting component comprises:
a plurality of light-emitting elements;
a thermally conductive plate, in which the plurality of light-emitting elements is disposed, the thermally conductive plate comprising:
a first coupling member, extending outward from a front sidewall of the thermally conductive plate near a bottom portion thereof; and
a second coupling member, extending outward from a rear sidewall of the thermally conductive plate near the bottom portion thereof; and
a plurality of electrical connection wires, each connected to one of the light-emitting elements and passing through the thermally conductive plate.

6. The solid-state light source device of claim 5, wherein the elastic member comprises:
a first top surface, respectively facing and contacting the first coupling member and the second coupling member;
a side surface, surrounding the light-emitting component;
a first bottom surface, connected to the side surface; and
an extension surface, extending outward from an outer side of the side surface, the extension surface and the first bottom surface forming a stepped structure.

7. The solid-state light source device of claim 6, wherein the first top surface is disposed above the first coupling member and the second coupling member.

8. The solid-state light source device of claim 7, wherein the first bottom surface is located above the first recess, and a bottom surface of the extension surface is located on a portion of the top surface of the liquid cooler.

9. The solid-state light source device of claim 8, wherein the elastic member further comprises:
a first rib, protruding downward from a bottom surface of the first bottom surface, and being annular; and
a second rib, protruding downward from a bottom surface of the extension surface, and being annular.

10. The solid-state light source device of claim 9, wherein the plate member surrounds the light-emitting component and has a first through hole, the plate member further comprising a second recess flaring outward from the first through hole.

11. The solid-state light source device of claim 10, wherein the circuit board surrounds the light-emitting component and has two protrusions; each of the protrusions having a plurality of side grooves, the side grooves being spaced apart from one another.

12. A projection apparatus, comprising:
a solid-state light source device, comprising:
a liquid cooler, comprising:
a chamber, a top surface of the chamber defining an opening;
a liquid inlet, formed on one sidewall of the chamber;
a liquid outlet, formed on another sidewall of the chamber; and
a light source module, disposed on a top surface of the liquid cooler and covering the opening.
an optical engine module, configured to receive a light beam emitted from the light source module and to convert it into an image beam; and
a projection lens, disposed on a transmission path of the image beam, for projecting the image beam.

13. A method for assembling a solid-state light source device, comprising:
providing a light-emitting component and an elastic member;
fitting the elastic member onto a bottom portion of the light-emitting component;
providing a liquid cooler, wherein the liquid cooler includes a chamber, a liquid inlet, and a liquid outlet, the chamber having an opening on a top surface, and the liquid inlet and the liquid outlet being located on two sidewalls of the chamber;
covering the opening with a bottom surface of the light-emitting component with the elastic member fitted thereon;
providing a plate member;
placing the plate member on the light-emitting component with the elastic member and on the liquid cooler, such that a portion of the light-emitting component is exposed through the plate member;
providing a circuit board;
placing the circuit board on the plate member and the liquid cooler, such that a portion of the light-emitting component with the elastic member and a portion of the plate member are exposed through the circuit board; and
translating the circuit board to a soldering position.

14. The method of claim 13, wherein after the step of placing the plate member on the light-emitting component with the elastic member and on the liquid cooler, such that a portion of the light-emitting component is exposed through the plate member, further comprises:
fastening the plate member to the liquid cooler with a plurality of screws, and fastening the plate member and the light-emitting component with the elastic member to the liquid cooler with a plurality of screws.

15. The method of claim 13, wherein after the step of translating the circuit board to the soldering position, further comprises:
fastening the circuit board to the liquid cooler with a plurality of screws.
